(19) United States
(12) Patent Application Publication
(10) Pub. No.: US 2022/0193482 A1
(43) Pub. Date: Jun. 23, 2022

(54) FAST-ADJUSTING DUMBBELL AND DUMBBELL KIT

(71) Applicant: Jing'ai HUANG, Yiwu City (CN)

(72) Inventors: Shiquan WU, Yiwu City (CN); Jing'ai HUANG, Yiwu City (CN)

(21) Appl. No.: 17/345,192

(22) Filed: Jun. 11, 2021

(30) Foreign Application Priority Data
Dec. 18, 2020 (CN) 202011509898.7

(51) Int. Cl. A63B 21/072; A63B 21/075

(52) U.S. Cl. CPC A63B 21/0728; A63B 21/075; A63B 21/0726

(57) ABSTRACT

The present invention relates to a fast-adjusting dumbbell, comprising a dumbbell body and dumbbell pieces cumulatively attached to both ends of the dumbbell body. The dumbbell body includes a grip rod, a planetary gear system, and a telescopic rod. The grip rod is rotated and drives the planetary gear system to realize the expansion and contraction of the telescopic rod, thereby adjusting the number of dumbbell pieces, which is convenient to operate and easy to implement. Both ends of the grip rod are assembled with flange driving members, the planetary gear system includes an outer casing, through the installation mode that the flange driving member is engaged with the planetary gear system, the planetary gear mechanism is disposed enclosedly, and a load-bearing iron ring is also disposed in the planetary gear system to play a load-bearing and limiting effect on the planetary carrier.

### RELATED APPLICATIONS

This application claims priority to Chinese Patent Application 202011509898.7, filed on Dec. 18, 2020, which is incorporated herein by reference.

### TECHNICAL FIELD

The present invention relates to the field of fitness equipment, in particular to a dumbbell of which the number of dumbbell pieces can be adjusted fast, and a dumbbell kit including a dumbbell and a dumbbell rack.

### BACKGROUND

Dumbbells, as commonly used fitness equipment, are loved by all kinds of fitness enthusiasts. The existing adjustable dumbbells, such as the most common nut locking type, require users to remove or mount dumbbell pieces one by one and then lock them with wrenches, which is complicated to use. In order to facilitate the adjustment of dumbbell pieces, as set forth in the patent with a publication number of CN111450475, the present invention realizes the adjustment of the number of dumbbell pieces by means of using the planetary gear mechanism to drive the telescopic rod to extend and retract. However, in this disclosure, it is chosen to expose a ring gear of the planetary gear mechanism, and input a driving force by manually toggling the ring gear to rotate. As the ring gear needs to be exposed, the sealing performance of the planetary gear mechanism is poor, dust is easy to enter during use, and the service life and reliability of the planetary gear mechanism are impaired. In addition, the operation mode of manually toggling the ring gear is relatively complicated, and the user is not easy to apply force.

### SUMMARY

Therefore, aiming at the above problems, the present invention provides a fast-adjusting dumbbell and a dumbbell kit with an optimized structure.

The present invention is realized by adopting the following technical solutions:

the present invention provides a fast-adjusting dumbbell, comprising a dumbbell body, fixed dumbbell pieces fixed at both ends of the dumbbell body and movable dumbbell pieces cumulatively mounted on the fixed dumbbell pieces, wherein the dumbbell body may include a grip rod, a planetary gear system and a telescopic rod, two ends of the grip rod are respectively provided with one planetary gear system, the planetary gear system includes a gear shaft, a planetary wheel, a planetary carrier and a ring gear, wherein the gear shaft is coaxially disposed with the grip rod as a sun gear, the planetary wheel is engaged with the gear shaft, the ring gear is engaged with the planetary wheel, the planetary carrier is fixedly disposed, the ring gear is in linkage connection with the grip rod, so that when the grip rod rotates, the ring gear is able to rotate synchronously with the grip rod, the gear shaft has a shaft hole through which the telescopic rod extends, the telescopic rod is helically driven to the gear shaft through a screw pair, so that when the gear shaft rotates, the telescopic rod is extendable or retractable in an axial direction of the gear shaft, the telescopic rod passes through center holes of the movable dumbbell pieces to hang the movable dumbbell pieces, thereby adjusting the number of movable dumbbell pieces at both ends of the dumbbell body.

Wherein, in order to improve the sealing performance of the planetary gear mechanism, and avoid dust affecting the operation of planetary gear mechanism, in an embodiment, the planetary gear system may further include an outer casing substantially half-enclosing the gear shaft, the planetary wheel, the planetary carrier and the ring gear, the dumbbell body may further include a flange driving member, which is fixedly assembled at both ends of the grip rod and is in linkage connection with the ring gear, so as to realize the synchronous rotation of the ring gear and the grip rod, the flange driving member is butted with the outer casing so as to surround and substantially enclose the ring gear, the planetary wheel, the planetary carrier and the gear shaft.

Wherein, based on manufacturing and installation considerations, it is preferable that the planetary carrier and the fixed dumbbell piece are fixedly connected to the outer casing, so that when the grip rod rotates, the outer casing and the planetary carrier are kept stationary by the gravity of the dumbbell plate.

Wherein, in order to ensure the structural strength, it is preferable that the planetary gear system may further include a load-bearing iron ring in an annular structure, the load-bearing iron ring is coaxially disposed with the ring gear and fixedly connected with the flange driving member, one end of the planetary carrier is fixed on the outer casing, and the other end is pressed against the load-bearing iron ring, so that the load-bearing iron ring restricts the movement of the planetary carrier and the outer casing toward the outside direction of the fixed dumbbell piece.

Specifically, based on manufacturing and installation considerations, it is preferable that the planetary carrier may be a revolving body structure with a substantially T-shaped cross-section, including a head with a larger outer diameter and a tail with a smaller outer diameter, the outer casing is provided with a planetary carrier fixing hole, the tail is plugged and fixed in the planetary carrier fixing hole, and the head is hooked against the load-bearing iron ring.

Wherein, based on manufacturing and installation considerations, it is preferable that the flange driving member may have a pin extending axially along the ring gear, the ring gear has a slot matching the pin, and the linkage connection between the flange driving member and the ring gear is realized by the plug-in fit of the pin and the slot.

Wherein, based on manufacturing and installation considerations, it is preferable that a body portion of the outer casing may be a lid-shaped revolving body structure with a substantially U-shaped cross-section, and a body portion of the flange driving member may be a funnel-shaped revolving body structure, the flange driving member may include a small-diameter end and a large-diameter end, wherein the small-diameter end is fixedly assembled with the grip rod, and the large-diameter end is butted with the outer casing, so that the ring gear, the planetary wheel, the planetary carrier and the gear shaft are surrounded and substantially closed by the outer casing and the flange driving member.

Wherein, in order to improve security, and prevent from rotating the grip rod by mistake when the dumbbell is in use, it is preferable that the fast-adjusting dumbbell further may include a locking element fixedly mounted on the outer casing, the locking element may include a base, a movable pin slidably mounted in the base and a compression spring, one end of the compression spring acts on the base, and the other end acts on the movable pin, thereby always giving the movable pin a tendency to move outward of the outer casing, the flange driving member may further include a locking ring extending into the outer casing, the locking ring is provided with a locking groove in the circumferential direction, and the shape of the movable pin matches the locking groove, so that the rotation of the flange driving member relative to the outer casing is limited through the cooperation of the movable pin and the locking groove, and the movable pin is exposed from the outer casing to cooperate with a dumbbell rack to realize a rotation unlocking of the flange driving member relative to the outer casing.

Based on the above fast-adjusting dumbbell, the present invention also provides a dumbbell kit including the above fast-adjusting dumbbell and a dumbbell rack for placing the fast-adjusting dumbbell, wherein the dumbbell rack is provided with a placement groove in which a protrusion for realizing the rotation unlocking of the flange driving member relative to the outer casing is provided.

The present invention has the following beneficial effects: the present invention realizes the extension and retraction of the telescopic rod by rotating the grip rod, and then adjust the number of dumbbell pieces, which is easy to operate and easy to implement, through the installation mode that the flange driving member is engaged with the planetary gear system, the planetary gear mechanism is disposed enclosedly to prevent dust accumulation from affecting the operation of the planetary gear mechanism, and a load-bearing iron ring is also disposed to solve the static maintenance of the outer casing of the planetary gear system and prevent relatively heavy dumbbell pieces from affecting the strength of the planetary gear system.

### BRIEF DESCRIPTION OF THE DRAWINGS

FIG. 1 is a schematic view of a fast-adjusting dumbbell in an embodiment;

FIG. 2 is a schematic view of a dumbbell body and a fixed dumbbell piece in an embodiment;

FIG. 3 is a schematic view of a movable dumbbell piece in an embodiment;

FIG. 4 is a schematic view of the dumbbell body in an embodiment;

FIG. 5 is a cross-sectional view of the dumbbell body in an embodiment;

FIG. 6 is a structural exploded view of the dumbbell body in an embodiment;

FIG. 7 is a schematic view of a grip rod and a flange driving member in an embodiment;

FIG. 8 is a schematic view (first angle) of the flange driving member in an embodiment;

FIG. 9 is a schematic view (second angle) of the flange driving member in an embodiment;

FIG. 10 is a schematic view (first angle) of a planetary gear system in an embodiment;

FIG. 11 is a of structural exploded view of the planetary gear system in an embodiment;

FIG. 12 is a schematic sectional view of a gear shaft in the embodiment;

FIG. 13 is a schematic view (second angle) of the planetary gear system in an embodiment;

FIG. 14 is a schematic view of a dumbbell piece mounting plate mounted at one end of the dumbbell body in an embodiment;

FIG. 15 is a schematic view of the dumbbell body, a dumbbell piece mounting plate and the fixed dumbbell piece in an embodiment;

FIG. 16 is a schematic view of a dumbbell kit in an embodiment; and

FIG. 17 is a schematic view of a dumbbell rack in an embodiment.

### DETAILED DESCRIPTION OF THE EMBODIMENTS

To further illustrate respective embodiments, the present invention is provided with the accompanying drawings. The drawings are a part of the disclosure of the present invention, which are mainly used to illustrate embodiments, and can be taken in conjunction with the relative depiction in the description to explain the operation principle of the embodiments. With reference to these contents, other possible embodiments and the advantages of the present invention will be understood by those ordinarily skilled in the art. The components in the drawings are not drawn to scale, and similar component signs are usually used to represent similar components.

The present invention will be further explained in conjunction with the drawings and the specific embodiments.

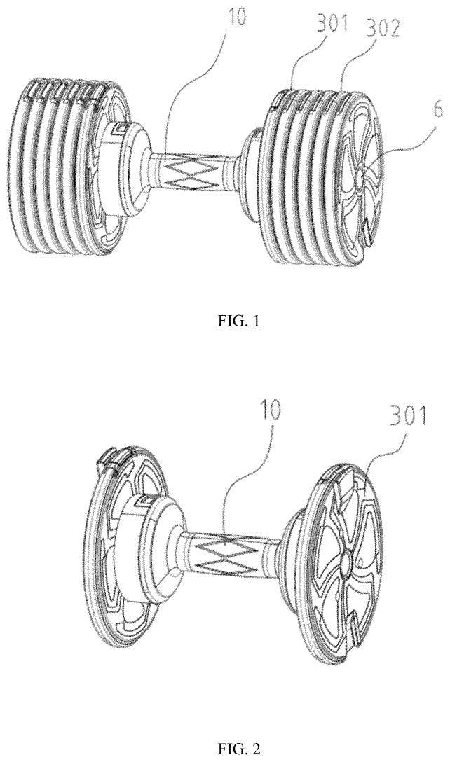

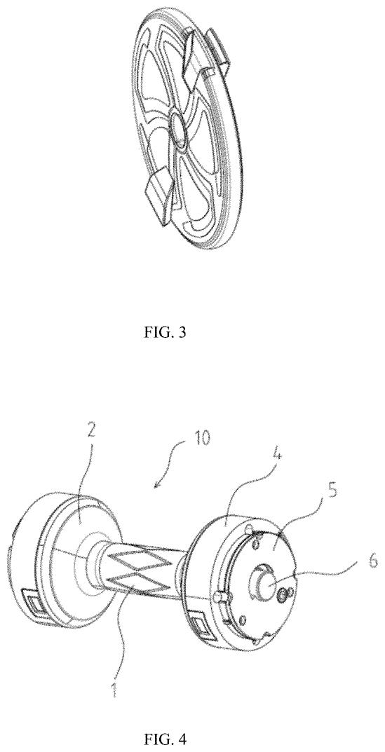

Referring to FIGS. 1-2, as a preferred embodiment of the present invention, a fast-adjusting dumbbell is provided, which includes a substantially I-shaped dumbbell body 10 and a plurality of dumbbell pieces mounted and disposed at both ends of the dumbbell body 10, the first dumbbell pieces at both ends of the dumbbell body 10 are fixedly connected with the dumbbell body 10, the remaining dumbbell pieces can be cumulatively mounted on the first dumbbell pieces at both ends of the dumbbell body 10. It is defined that the first dumbbell piece fixedly connected to the both ends of the dumbbell body 10 is a fixed dumbbell piece 301, and the dumbbell piece that can be cumulatively mounted on the fixed dumbbell piece is a movable dumbbell piece 302, as shown in FIG. 3, both sides of each dumbbell piece are symmetrically provided with a dovetail tenon and a dovetail groove, and an accumulation of dumbbell pieces is realized by clamping of the dovetail tenon and the dovetail groove on adjacent dumbbell pieces. In other embodiments, the fixed dumbbell pieces may be two, three, and other numbers at each end of the dumbbell body 10.

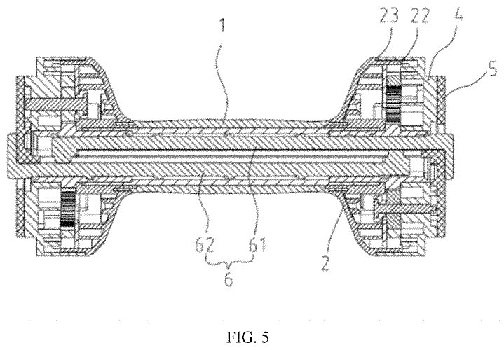

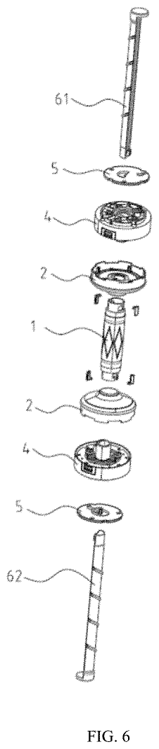

Referring to FIGS. 4-6, the dumbbell body 10 includes a grip rod 1, a flange driving members 2 fixedly disposed at both ends of the grip rod 1, a planetary gear system 4 in driven connection with the flange driving member 2, and a telescopic rod assembly 6 extending inside the dumbbell body 10. The telescopic rod assembly 6 includes a first telescopic rod 61 and a second telescopic rod 62 substantially in the shape of a semicircular shaft. By rotating the grip rod 1, and via the transmission of the flange driving member 2 and the planetary gear system 4, the dumbbell body 10 finally makes the first telescopic rod 61 and the second telescopic rod 62 extend or retract synchronously and away from each other. The first telescopic rod 61 and the second telescopic rod 62 hang the dumbbell piece through a center hole of the dumbbell piece, so as to adjust the number of dumbbell pieces at both ends of the dumbbell body 10. The specific structure and the implementation will be described in detail below.

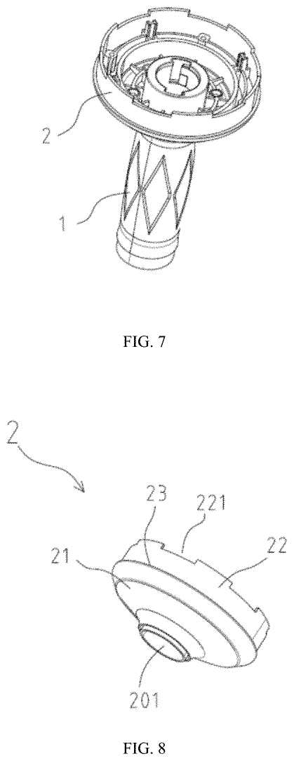

Referring to FIG. 5 and FIGS. 7-9, the grip rod 1 is tubular in shape and has a center hole for the telescopic rod assembly 6 to extend through, an outer surface of the grip rod 1 has a concave-convex texture, to increase the friction of the user's grip. The grip rod 1 and the flange driving member 2 are fixedly assembled together. The flange driving member 2 is in a substantially funnel shape with a center hole 201, includes a housing portion formed by joining of the housing 21 and a locking ring 22, and further includes a screw hole 25, a first pin 26 and a steel ball groove 27 formed in an interior enclosed by the housing portion. The first pin 26 protrudes in an axial direction of the flange driving member 2. The housing 21 is in the shape of a shrunken cone and includes a small-diameter end toward the grip rod 1 and a large-diameter end toward the planetary gear system 4. The small-diameter end is fixedly assembled with the grip rod 1, and an outer diameter of the large-diameter end is substantially equal to that of an outer casing 41 of the planetary gear system 4, so that the large-diameter end is butted with the outer casing 41 of the planetary gear system 4 to substantially close the planetary gear mechanism and prevent problems such as the entry of dust. The large-diameter end is also connected with the locking ring 22 through a reduced diameter step 23, the locking ring 22 is annular, and its free end is evenly provided with a plurality of notch-shaped locking grooves 221. When the flange driving member 2 and the planetary gear system 4 are engaged together, the locking ring 22 extends into the outer casing 41 of the planetary gear system 4, so that the locking groove 221 cooperates with a locking element 40 on the planetary gear system 4 to realize the rotation locking of the flange driving member 2 and the grip rod 1 relative to the outer casing 41. At the same time, the locking ring 22 extending into the outer casing 41 can further improve the sealing performance of the planetary gear mechanism.

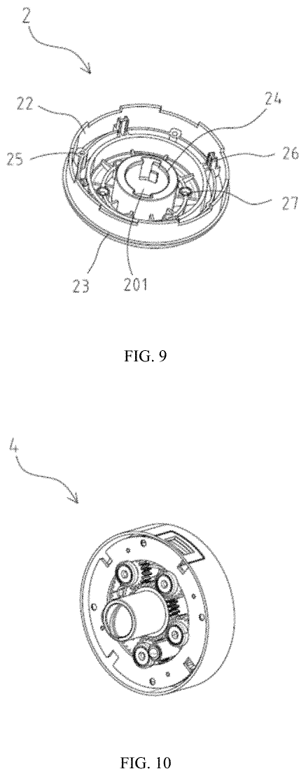

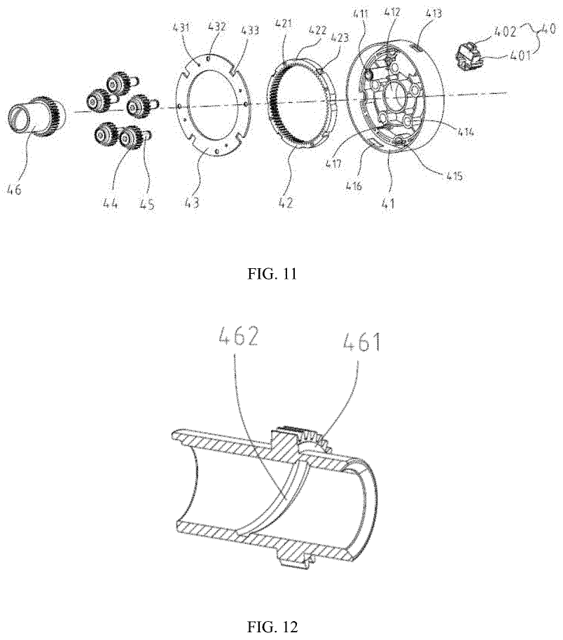

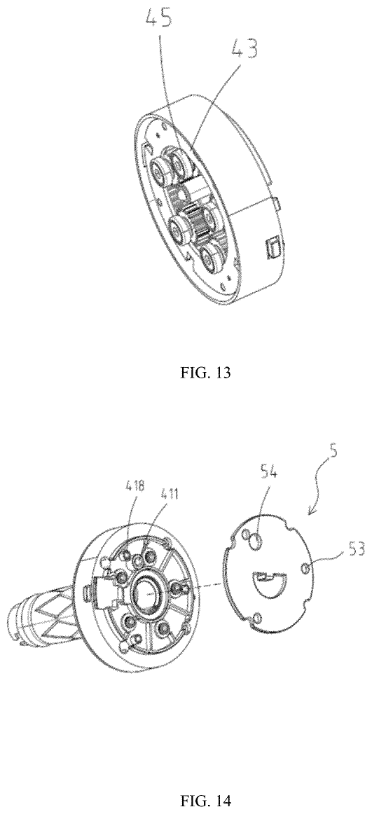

Referring to FIGS. 10-13, the planetary gear system 4 includes the outer casing 41, a ring gear 42 provided inside the outer casing 41, a load-bearing iron ring 43, a planetary wheel 44, a planetary carrier 45, a gear shaft 46 serving as a sun wheel, and the locking element 40 assembled on the outer casing 41. The gear shaft 46 includes a shaft and a first gear 461 as an integral. The gear shaft 46 has a hollow shaft hole, whose inner wall is provided with a concave helical groove 462 that is used to engage with an external thread of the first telescopic rod 61 or the second telescopic rod 62, so that when the gear shaft 46 is rotated, it drives the first telescopic rod 61 and the second telescopic rod 62 to extend or retract. The planetary carrier 45 is a revolving body with a substantially T-shaped cross-section, includes a head with a larger outer diameter and a tail with a smaller outer diameter. The planetary wheel 44 is rotatably sleeved on the planetary carrier 45, the outer casing 41 is formed with a planetary carrier mounting hole 414 where the tail of the planetary carrier 45 is inserted and fixed, so that the planetary wheel 44 is mounted on the outer casing 41 through the planetary carrier 45, the planetary carrier 45 is also hooked against the load-bearing iron ring 43 (FIG. 13). The load-bearing iron ring 43 forms an axial limit to the planetary carrier 45 and the outer casing 41. As the outer casing 41 and the fixed dumbbell piece 301 are fixedly connected as a whole, when the user lifts the dumbbell, due to the weight of dumbbells, it is possible to have a tendency to move the outer casing 41, the planetary carrier 45 and the planetary wheel 44 towards or away from the flange driving member 2, when the outer casing 41, the planetary carrier 45 and the planetary wheel 44 have a tendency to move away from the flange driving member 2, the gravity of the dumbbell piece acts on the load-bearing iron ring 43 through the planetary carrier 45, thereby preventing the outer casing 41, the planetary carrier 45, the planetary wheel 44 and the dumbbell piece from falling out and causing potential safety hazards, and the load-bearing iron ring 43 also plays a load-bearing role to ensure the structural strength of the dumbbell. In this embodiment, five planetary wheels 44 are provided in a circular arrangement. In other embodiments, other suitable numbers of planetary wheels can be selected according to the load born by the planetary wheels. The ring gear 42 is engaged with the planetary wheel 44. The outer casing 41 has the center hole 412 for cooperating with the gear shaft 46. One end of the gear shaft 46 is inserted into the center hole 412, and the first gear 461 on the gear shaft 46 is engaged with the planetary wheel 44, so that the ring gear 42, the planetary wheel 44, the planetary carrier 45 and the first gear 461 form a planetary gear mechanism, the first gear 461 serves as a sun wheel, when the ring gear 42 is actively rotated, the first gear 461 is passively rotated, and the planetary gears form a speed-up transmission relationship.

The load-bearing iron ring 43 and the ring gear 42 are assembled and fixed, wherein an end face of the ring gear 42 is provided with the boss 421 protruding in its axial direction, and the load-bearing iron ring 43 is provided with the insertion hole 431 corresponding to the boss 421. The boss 421 is inserted into the insertion hole 431 to realize the cooperation of the load-bearing iron ring 43 and the ring gear 42. The load-bearing iron ring 43 is also fixedly assembled with the flange driving member 2, wherein the ring gear 42 and the load-bearing iron ring 43 are respectively provided with the first slot 423 and the second slot 433 at corresponding positions for the first pin 26 to be inserted and cooperated. The load-bearing iron ring 43 is provided with a through hole 432, the position of the through hole 432 corresponds to the screw hole 25 of the flange driving member 2. When the flange driving member 2 and the planetary gear system 4 are engaged, the first pin 26 is aligned to insert into the first slot 423 (the second slot 433) to complete the positioning, and then a screw is passed through the through hole 432 and locked in the screw hole 25, so that the load-bearing iron ring 43, the ring gear 42 and the flange driving member 2 are connected into a whole. In order to facilitate the mounting and locking of the screws, the outer ring of the ring gear 42 is also provided with a groove 422 for giving way to the screws, and the outer casing 41 is formed with a screw placement hole 415. Through the assembling relationship that the load-bearing iron ring 43, the ring gear 42 and the flange driving member 2 are connected into a whole, as the flange driving member 2 is rotated, the ring gear 42 can be rotated, and since the flange driving member 2 is fixedly assembled with the grip rod 1, when the grip rod 1 is rotated, the ring gear 42 can be rotated, and then through the transmission of the planetary gear mechanism, the gear shaft 46 is rotated, then the gear shaft 46 drives the first telescopic rod 61 and the second telescopic rod 62 to extend or retract through the engagement of the helical groove 462 inside its shaft hole and the external thread on the first telescopic rod 61 or the second telescopic rod 62.

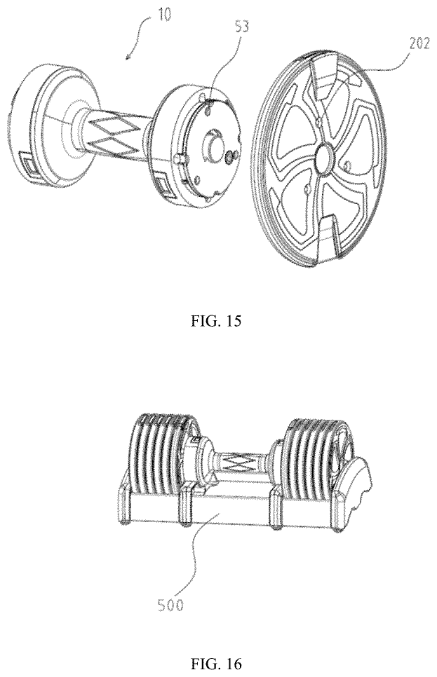

As shown in FIGS. 4-5 and FIGS. 14-15, the outer casing 41 is also fixedly assembled with the dumbbell piece mounting plate 5, which is used to mount the fixed dumbbell piece 301, that is, the outer casing 41, the dumbbell piece mounting plate 5 and the fixed dumbbell piece 301 are fixedly connected together, so that by the gravity of the dumbbell pieces, the outer casing 41 is able to kept stationary when the grip rod 1 is rotated. Specifically, the present embodiment uses screw connection to fixedly connect the three, a hexagonal socket 417 for mounting a nut is provided inside the outer casing 41, a hollow column 418 communicating with the hexagonal socket 417 is provided on an outer surface of the outer casing 41 corresponding to the hexagonal socket 417. A mounting post of the steel ball assembly 411 protrudes from the outer surface of the outer casing 41 as a positioning post, a first positioning hole 53 and a second positioning hole 54 are provided in the dumbbell piece mounting plate 5 corresponding to the hollow column 418 and the mounting post of the steel ball assembly 411. The positioning of the dumbbell piece mounting plate 5 is accomplished by inserting the hollow column 418 and the mounting post of the steel ball assembly 411 into the first positioning hole 53 and the second positioning hole 54 respectively. Corresponding to the first positioning hole 53, the fixed dumbbell piece 301 is provided with the counterbore 202, and a screw is used to pass through the counterbore 202 and the first positioning hole 53 to be locked in the nut mounted in the hexagonal socket 417 to complete the fixedly connection of the outer casing 41, the dumbbell piece mounting plate 5 and the fixed dumbbell piece 301.

In this embodiment, when the grip rod 1 is rotated, the flange driving member 2 fixedly assembled with the grip rod 1 is rotated synchronously, and the flange driving member 2 drives the planetary gear mechanism to rotate the gear shaft 46. Through the transmission of the planetary gear mechanism, it realizes that when the grip rod 1 is rotated at a smaller angle, then the gear shaft 46 will be rotated at a larger angle, thereby efficiently and accurately controlling the expansion and retraction of the telescopic rod assembly 6.

Continuously rotating the grip rod 1, then the first telescopic rod 61 and the second telescopic rod 62 continue to extend or retract, when the ring gear 42 rotates, the outer casing 41 is stationary, by means of the rotation of the flange driving member 2 relative to the outer casing 41, the steel ball assembly 411 is provide in the outer casing 41. As shown in FIG. 11, the steel ball assembly 411 includes a protruding mounting post and steel balls mounted in the mounting post by a spring. As shown in FIG. 9, six steel ball grooves 27 are arranged circumferentially on the flange driving member 2, when the flange driving member 2 is rotated relative to the outer casing 41, the steel balls fall into the steel ball grooves 27 and make a “click” sound to remind the user that the grip rod 1 has been rotated to a gear position (e.g., it has been rotated to the position of four, six, and eight dumbbell pieces). The number of the steel ball grooves 27 is determined according to the number of dumbbell pieces that is able to be adjusted by the product. At the same time, in this embodiment, the outer casing 41 is also provided with a window 416, and an outer circle of the ring gear 42 can be marked with a scale, so that the user can also determine the gear position by observing the window 416.

In order to avoid potential safety hazards caused by erroneous rotation of the grip rod 1 when lifting dumbbells, the embodiment is also provided with a means for performing rotation locking on the grip rod 1. Continuing to refer to FIG. 11, the locking element 40 is mounted on the outer casing 41. The locking element 40 includes a base 401 and a movable pin 402. The movable pin 402 is slidably mounted in the base 401, and the movable pin always has a tendency to move radially outward toward the outer casing 41 by a compression spring (not shown) mounted between the base 401 and the movable pin 402. As can be seen above, the locking ring 22 of the flange driving member 2 extends into the outer casing 41 of the planetary gear system 4, therefore, the movable pin 402 is inserted into the locking groove 221 of the locking ring 22 to limit the rotation of the grip rod 1 and the flange driving member 2. The outer casing 41 is also provided with the exposure hole 413 for exposing the movable pin 402.

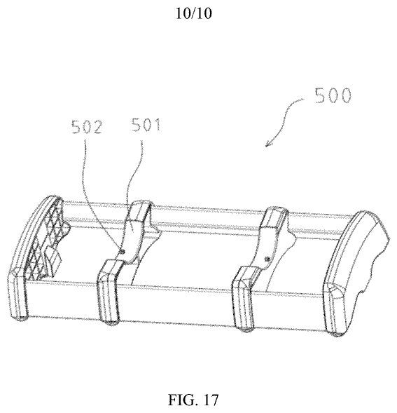

Therefore, when it is necessary to rotate the grip rod 1 to adjust the number of dumbbell pieces, the movable pin 402 needs to be pressed, so as not to obstruct the rotation of the flange driving member 2. Therefore, this embodiment also provides a dumbbell kit, which includes the aforementioned fast-adjusting dumbbell and a dumbbell rack 500 for placing the fast-adjusting dumbbell. As shown in FIGS. 16-17, the dumbbell rack 500 is provided with the placement groove 501 that matches the shape of the outer casing 41, a protrusion 502 is provided inside the placement groove 501, when the fast-adjusting dumbbell is placed on the dumbbell rack 500, the protrusion 502 presses against the movable pin 402 to unlock the flange driving member 2 and the outer casing 41, so that the grip rod 1 can rotate to adjust the number of dumbbell pieces. After picking up the fast-adjusting dumbbell, the movable pin 402 locks the flange driving member 2 and the outer casing 41 due to the elastic force received by the movable pin 402, thereby ensuring that the grip rod 1 will not be rotated by mistake, causing potential safety hazards.

Although the present invention has been particularly shown and described in conjunction with preferred embodiments, those skilled in the art should understand that various changes in form and detail may be made to the present invention without departing from the spirit and scope of the present invention as defined by the appended claims, which fall within the protection scope of the present invention.

What is claimed is:

1. A fast-adjusting dumbbell, comprising:
a dumbbell body,
fixed dumbbell pieces fixed at both ends of the dumbbell body, and
movable dumbbell pieces cumulatively mounted on the fixed dumbbell pieces, wherein:
the dumbbell body comprises a grip rod, two planetary gear systems, and a telescopic rod,
two ends of the grip rod are respectively provided with one of the two planetary gear systems,
each of the two planetary gear systems comprises a gear shaft, a planetary wheel, a planetary carrier, and a ring gear, wherein
the gear shaft is coaxially disposed with the grip rod to define a sun gear,
the planetary wheel is engaged with the gear shaft,
the ring gear is engaged with the planetary wheel,
the planetary carrier is fixedly disposed,
the ring gear is in linkage connection with the grip rod so that when the grip rod rotates, the ring gear is able to rotate synchronously with the grip rod,
the gear shaft has a shaft hole through which the telescopic rod extends, and
the telescopic rod is helically driven by the gear shaft through a screw pair so that when the gear shaft rotates, the telescopic rod is extended or retracted in an axial direction of the gear shaft, and the telescopic rod passes through a center hole of the movable dumbbell pieces for hanging the movable dumbbell pieces, thereby adjusting a number of movable dumbbell pieces at the both ends of the dumbbell body.

2. The fast-adjusting dumbbell according to claim 1, wherein:
each of the two planetary gear systems further comprises an outer casing half-enclosing the gear shaft, the planetary wheel, the planetary carrier, and the ring gear,
the dumbbell body further comprises a flange driving member, which is fixedly disposed at the two ends of the grip rod and is in linkage connection with the ring gear, so as to realize the synchronous rotation of the ring gear and the grip rod, and
the flange driving member is butted with the outer casing so as to surround and enclose the ring gear, the planetary wheel, the planetary carrier, and the gear shaft.

3. The fast-adjusting dumbbell according to claim 2, wherein the planetary carrier and the fixed dumbbell pieces are fixedly connected to the outer casing so that when the grip rod rotates, the outer casing and the planetary carrier are kept stationary by gravity of the fixed dumbbell pieces.

4. The fast-adjusting dumbbell according to claim 3, wherein:
each of the two planetary gear systems further comprises a load-bearing iron ring in an annular structure,
the load-bearing iron ring is coaxially disposed with the ring gear and is fixedly connected with the flange driving member, and
one end of the planetary carrier is fixed on the outer casing and the other end of the planetary carrier is pressed against the load-bearing iron ring, so that the load-bearing iron ring restricts movement of the planetary carrier and the outer casing toward an outside direction of the fixed dumbbell pieces.

5. The fast-adjusting dumbbell according to claim 4, wherein:
the planetary carrier is a revolving body structure with a T-shaped cross-section comprising a head with a larger outer diameter and a tail with a smaller outer diameter,
the outer casing is provided with a planetary carrier fixing hole,
the tail is plugged and fixed in the planetary carrier fixing hole, and
the head is hooked against the load-bearing iron ring.

6. The fast-adjusting dumbbell according to claim 2, wherein:
the flange driving member has a pin extending axially along the ring gear,
the ring gear has a slot matching the pin, and
the linkage connection between the flange driving member and the ring gear is realized by a plug-in fit of the pin and the slot.

7. The fast-adjusting dumbbell according to claim 2, wherein:
a body portion of the outer casing is a lid-shaped revolving body structure with a U-shaped cross-section,
a body portion of the flange driving member is a funnel-shaped revolving body structure,
the flange driving member comprises a small-diameter end and a large-diameter end,
the small-diameter end is fixedly assembled with the grip rod, and
the large-diameter end is butted with the outer casing, so that the ring gear, the planetary wheel, the planetary carrier, and the gear shaft are surrounded and closed by the outer casing and the flange driving member.

8. The fast-adjusting dumbbell according to claim 2, wherein:
the fast-adjusting dumbbell further comprises a locking element,
the locking element is fixedly mounted on the outer casing,
the locking element comprises a base, a movable pin slidably mounted in the base, and a compression spring,
one end of the compression spring acts on the base and the other end of the compression spring acts on the movable pin, thereby always giving the movable pin a tendency to move outward from the outer casing,
the flange driving member further comprises a locking ring extending into the outer casing,
the locking ring is provided with a locking groove in a circumferential direction of the locking ring,
a shape of the movable pin matches the locking groove so that a rotation of the flange driving member relative to the outer casing is limited through cooperation of the movable pin and the locking groove, and
the movable pin is exposed to the outer casing to cooperate with a dumbbell rack to realize a rotation unlocking of the flange driving member relative to the outer casing.

9. A dumbbell kit, comprising:
a fast-adjusting dumbbell, and
a dumbbell rack for placing the fast-adjusting dumbbell, wherein the fast-adjusting dumbbell comprises:
a dumbbell body,
fixed dumbbell pieces fixed at both ends of the dumbbell body, and
movable dumbbell pieces cumulatively mounted on the fixed dumbbell pieces, wherein:
the dumbbell body comprises a grip rod, two planetary gear systems, and a telescopic rod,
two ends of the grip rod are respectively provided with one of the two planetary gear systems,
each of the two planetary gear systems comprises a gear shaft, a planetary wheel, a planetary carrier, and a ring gear, wherein
the gear shaft is coaxially disposed with the grip rod to define a sun gear,
the planetary wheel is engaged with the gear shaft,
the ring gear is engaged with the planetary wheel,
the planetary carrier is fixedly disposed,
the ring gear is in linkage connection with the grip rod so that when the grip rod rotates, the ring gear is able to rotate synchronously with the grip rod,
the gear shaft has a shaft hole through which the telescopic rod extends, and
the telescopic rod is helically driven by the gear shaft through a screw pair so that when the gear shaft rotates, the telescopic rod is extended or retracted in an axial direction of the gear shaft, and the telescopic rod passes through a center hole of the movable dumbbell pieces for hanging the movable dumbbell pieces, thereby adjusting a number of movable dumbbell pieces at the both ends of the dumbbell body,
the dumbbell rack has a placement groove in which a protrusion for realizing a rotation unlocking of a flange driving member of the dumbbell body relative to an outer casing of each of the two planetary gear systems is provided.

10. The dumbbell kit according to claim 9, wherein:
each of the two planetary gear systems further comprises an outer casing half-enclosing the gear shaft, the planetary wheel, the planetary carrier, and the ring gear,
the dumbbell body further comprises a flange driving member, which is fixedly disposed at the two ends of the grip rod and is in linkage connection with the ring gear, so as to realize the synchronous rotation of the ring gear and the grip rod, and
the flange driving member is butted with the outer casing so as to surround and enclose the ring gear, the planetary wheel, the planetary carrier, and the gear shaft.

11. The dumbbell kit according to claim 10, wherein the planetary carrier and the fixed dumbbell pieces are fixedly connected to the outer casing so that when the grip rod rotates, the outer casing and the planetary carrier are kept stationary by gravity of the fixed dumbbell pieces.

12. The dumbbell kit according to claim 11, wherein:
each of the two planetary gear systems further comprises a load-bearing iron ring in an annular structure,
the load-bearing iron ring is coaxially disposed with the ring gear and is fixedly connected with the flange driving member, and
one end of the planetary carrier is fixed on the outer casing and the other end of the planetary carrier is pressed against the load-bearing iron ring, so that the load-bearing iron ring restricts movement of the planetary carrier and the outer casing toward an outside direction of the fixed dumbbell pieces.

13. The dumbbell kit according to claim 12, wherein:
the planetary carrier is a revolving body structure with a T-shaped cross-section comprising a head with a larger outer diameter and a tail with a smaller outer diameter,
the outer casing is provided with a planetary carrier fixing hole,
the tail is plugged and fixed in the planetary carrier fixing hole, and
the head is hooked against the load-bearing iron ring.

14. The dumbbell kit according to claim 10, wherein:
the flange driving member has a pin extending axially along the ring gear,
the ring gear has a slot matching the pin, and
the linkage connection between the flange driving member and the ring gear is realized by a plug-in fit of the pin and the slot.

15. The dumbbell kit according to claim 10, wherein:
a body portion of the outer casing is a lid-shaped revolving body structure with a U-shaped cross-section,
a body portion of the flange driving member is a funnel-shaped revolving body structure,
the flange driving member comprises a small-diameter end and a large-diameter end,
the small-diameter end is fixedly assembled with the grip rod, and
the large-diameter end is butted with the outer casing, so that the ring gear, the planetary wheel, the planetary carrier, and the gear shaft are surrounded and closed by the outer casing and the flange driving member.

16. The dumbbell kit according to claim 10, wherein:
the fast-adjusting dumbbell further comprises a locking element,
the locking element is fixedly mounted on the outer casing,
the locking element comprises a base, a movable pin slidably mounted in the base, and a compression spring,
one end of the compression spring acts on the base and the other end of the compression spring acts on the movable pin, thereby always giving the movable pin a tendency to move outward from the outer casing,
the flange driving member further comprises a locking ring extending into the outer casing,
the locking ring is provided with a locking groove in a circumferential direction of the locking ring,
a shape of the movable pin matches the locking groove so that a rotation of the flange driving member relative to the outer casing is limited through cooperation of the movable pin and the locking groove, and
the movable pin is exposed to the outer casing to cooperate with the dumbbell rack to realize a rotation unlocking of the flange driving member relative to the outer casing.
